(19) United States
(12) Patent Application Publication
(10) Pub. No.: US 2025/0275633 A1
(43) Pub. Date: Sep. 4, 2025

(54) AIR MATTRESS MANUFACTURING APPARATUS, AIR MATTRESS MANUFACTURING METHOD USING SAME, AND AIR MATTRESS MANUFACTURED USING MANUFACTURING METHOD

(71) Applicant: Anssil Co., Ltd., Gwangju-si (KR)

(72) Inventor: Beom Keun SONG, Suwon-si (KR)

(73) Assignee: Anssil Co., Ltd., Gwangju-si (KR)

(21) Appl. No.: 19/211,257

(22) Filed: May 18, 2025

Related U.S. Application Data
(63) Continuation of application No. PCT/KR2023/013807, filed on Sep. 14, 2023.

(30) Foreign Application Priority Data
Nov. 18, 2022 (KR) 10-2022-0155187

(51) Int. Cl. A47C 27/08; B29C 65/20; B29C 65/48; B29L 31/00

(52) U.S. Cl. CPC A47C 27/081; B29C 65/20; B29C 65/48; B29L 2031/751

(57) ABSTRACT

An air mattress manufacturing apparatus according to the present invention comprises: a first support jig having a upper surface on which a center portion of a shape-maintaining member temporarily attached to a corner side surface of a mattress body is placed by a worker; a first pressing unit for pressing the center portion of the shape-maintaining member placed on the upper surface of the first support jig and adhering same to the corner side surface of the mattress body; a second support jig having a upper surface on which the upper end portion of the shape-maintaining member temporarily attached to a corner upper surface of the mattress body and the lower end portion of the shape-maintaining member temporarily attached to a corner lower surface of the mattress body are placed by the worker after the center portion of the shape-maintaining member adhered to the corner side surface of the mattress body by the first pressing unit is vertically folded in half together with the corner side surface of the mattress body; and a second pressing unit for pressing the upper end portion of the shape-maintaining member placed on the upper surface of the second support jig and adhering same to the corner upper surface of the mattress body, or pressing the lower end portion of the shape-maintaining member placed on the upper surface of the second support jig and adhering same to the corner lower surface of the mattress body, and thus the present invention can firmly adhere the shape-maintaining members to four corner portions of the mattress body, and can prevent burns to the worker.

### TECHNICAL FIELD

The present invention relates to an air mattress manufacturing apparatus, an air mattress manufacturing method using the same, and an air mattress manufactured using the manufacturing method, and in particular, present invention relates to an air mattress manufacturing apparatus for adhering shape-maintaining members to four corner portions of a mattress body so that the mattress body maintains a hexahedron, an air mattress manufacturing method using the same, and an air mattress manufactured using the manufacturing method.

### BACKGROUND ART

Typically, a bed consists of a bed frame and a mattress that is installed on the upper surface of the bed frame to support the user.

As for the above mattress, a mattress having a plurality of springs installed therein to support the load of a user using cushioning force, or formed of a material having its own cushioning force, such as latex foam, is commonly used, although mattresses having water or air injected therein are also used.

Among these, air mattresses that are filled with air inside are not only light but also have the advantage of being easy to adjust for strength and height by controlling the amount of air injected inside.

Recently, a string air mattress has been developed in which the upper plate portion and lower plate portion of the air mattress are connected by a plurality of strings. The string air mattress has the cushioning force of the air filled inside as well as the elasticity of the strings provided inside, so it has the advantage of being light in weight but with greatly enhanced cushioning force.

Korean Patent Registration No. 10-1980575 (May 21, 2019) (hereinafter referred to as “prior art”) discloses a technology related to the string air mattress, “Method of manufacturing 3D air mat and it made thereby.”

The above prior art adheres a sealing tape to the entire edge of the interlocked lower fabric and upper fabric of a semi-assembled air mattress, and then adheres a shape-maintaining member from the lower surface of the lower coated surface of the lower fabric to the outer surface of the sealing tape and the upper surface of the upper coated surface of the upper fabric so that the corner portion of the air mattress is not distorted or crumpled.

However, in the above-mentioned prior art, since the adhesion process of the shape-maintaining member was performed manually by a worker, there was a problem of reduced adhesive strength, and there was also a problem of the worker sustaining burns in the process of applying hot air to the shape-maintaining member to improve the adhesive strength of the shape-maintaining member.

### DISCLOSURE

### Technical Problem

The problem to be solved by the present invention is to provide an air mattress manufacturing apparatus capable of firmly adhering a shape-maintaining member to the four corner portions of a mattress body and preventing burns to a worker, an air mattress manufacturing method using the same, and an air mattress manufactured using the manufacturing method.

The tasks of the present invention are not limited to the tasks mentioned above, and other tasks not mentioned will be clearly understood by those skilled in the art from the description below.

### Technical Solution

In order to achieve the above task, an air mattress manufacturing apparatus according to the present invention is an apparatus for adhering a shape-maintaining member to each of the four corner portions of a mattress body. Here, the shape-maintaining members are adhered to the four corner portions of the mattress body to maintain the mattress body in a hexahedron. The air mattress manufacturing apparatus according to the present invention includes a first support jig, a first pressing unit, a second support jig, and a second pressing unit. A center portion of the shape-maintaining member temporarily attached to a corner side surface of the mattress body is placed on an upper surface of the first support jig by a worker. The first pressing unit presses the center portion of the shape-maintaining member placed on the upper surface of the first support jig to adhere it to the corner side surface of the mattress body. After the center portion of the shape-maintaining member adhered to the corner side surface of the mattress body by the first pressing unit is vertically folded in half together with the corner side surface of the mattress body by the worker, an upper end portion of the shape-maintaining member temporarily attached to a corner upper surface of the mattress body and a lower end portion of the shape-maintaining member temporarily attached to a corner lower surface of the mattress body are placed on an upper surface of the second support jig by the worker. The second pressing unit presses the upper end portion of the shape-maintaining member placed on the upper surface of the second support jig to adhere it to the corner upper surface of the mattress body, or presses the lower end portion of the shape-maintaining member placed on the upper surface of the second support jig to adhere it to the corner lower surface of the mattress body.

The upper surface of the first support jig may be formed as a horizontal plane. The upper surface of the second support jig may be formed as an upwardly pointed cone shape.

The first pressing unit may include a first heating presser and a first cooling presser. The first heating presser may heat and press the center portion of the shape-maintaining member placed on the upper surface of the first support jig. The first cooling presser may press the center portion of the shape-maintaining member pressed by the first heating presser without applying heat. The second pressing unit may include a second heating presser and a second cooling presser. The second heating presser may heat and press the upper end portion of the shape-maintaining member placed on the upper surface of the second support jig, or the lower end portion of the shape-maintaining member placed on the upper surface of the second support jig. The second cooling presser may press the upper end portion of the shape-maintaining member pressed by the second heating presser without applying heat, or may press the lower end portion of the shape-maintaining member pressed by the second heating presser without applying heat.

The first pressing unit may further include a first guide jig. The first guide jig may have a first guide hole formed therein. The first guide jig may be moved to the first support jig such that an upper end portion of the first support jig is inserted into the first guide hole, thereby fixing the mattress body placed on the upper surface of the first support jig. The second pressing unit may further include a second guide jig. The second guide jig may have a second guide hole formed therein. The second guide jig may be moved to the second support jig such that an upper end portion of the second support jig is inserted into the second guide hole, thereby fixing the mattress body placed on the upper surface of the second support jig.

The first guide jig and the second guide jig may be arranged to be movable forward, backward, upward and downward.

The first pressing unit may further include a first linear rail and a first alignment slider. The first alignment slider may have the first heating presser and the first cooling presser installed thereon. The first alignment slider may be slid leftward and rightward along the first linear rail to align one of the first heating presser and the first cooling presser to an upper side of the first guide hole. The second pressing unit may further include a second linear rail and a second alignment slider. The second alignment slider may have the second heating presser and the second cooling presser installed thereon. The second alignment slider may be slid leftward and rightward along the second linear rail to align one of the second heating presser and the second cooling presser to an upper side of the second guide hole.

An air mattress manufacturing method according to the present invention is a method for adhering a shape-maintaining member to each of the four corner portions of a mattress body. Here, the shape-maintaining members are adhered to the four corner portions of the mattress body to maintain the mattress body in a hexahedron. The air mattress manufacturing method according to the present invention includes a first preparation step, a first adhesion step, a second preparation step, and a second adhesion step. In the first preparation step, the center portion of the shape-maintaining member temporarily attached to the corner side surface of the mattress body is placed on the upper surface of a first support jig by a worker. In the first adhesion step, the center portion of the shape-maintaining member placed on the upper surface of the first support jig is pressed by a first pressing unit to be adhered to the corner side surface of the mattress body. In the second preparation step, the center portion of the shape-maintaining member adhered to the corner side surface of the mattress body by the first pressing unit is vertically folded in half together with the corner side surface of the mattress body by the worker, and an upper end portion of the shape-maintaining member temporarily attached to the corner upper surface of the mattress body and a lower end portion of the shape-maintaining member temporarily attached to the corner lower surface of the mattress body on the upper surface of the second support jig by the worker. In the second adhesion step, the upper end portion of the shape-maintaining member placed on the upper surface of the second support jig is pressed by the second pressing unit to be adhered to the corner upper surface of the mattress body, or the lower end portion of the shape-maintaining member placed on the upper surface of the second support jig is pressed by the second pressing unit to be adhered to the corner lower surface of the mattress body.

The upper surface of the first support jig may be formed as a horizontal plane. The upper surface of the second support jig may be formed as an upwardly pointed cone shape.

The first adhesion step may include a first-first adhesion step and a first-second adhesion step. In the first-first adhesion step, the center portion of the shape-maintaining member placed on the upper surface of the first support jig may be heated and pressed by a first heating presser of the first pressing unit. In the first-second adhesion step, the center portion of the shape-maintaining member pressed by the first heating presser may be pressed by a first cooling presser of the first pressing unit without applying heat. The second adhesion step may include a second-first adhesion step and a second-second adhesion step. In the second-first adhesion step, the upper end portion of the shape-maintaining member placed on the upper surface of the second support jig may be heated and pressed by a second heating presser of the second pressing unit, or the lower end portion of the shape-maintaining member placed on the upper surface of the second support jig may be heated and pressed by the second heating presser. In the second-second adhesion step, the upper end portion of the shape-maintaining member pressed by the second heating presser may be pressed by a second cooling presser of the second pressing unit without applying heat, or the lower end portion of the shape-maintaining member pressed by the second heating presser may be pressed by the second cooling presser without applying heat.

The air mattress manufacturing method according to the present invention may further include a first mattress body fixing step and a second mattress body fixing step. The first mattress body fixing step may be performed after the first preparation step and before the first-first adhesion step. In the first mattress body fixing step, the mattress body placed on the upper surface of the first support jig may be fixed by moving a first guide jig of the first pressing unit such that the upper end portion of the first support jig is inserted into a first guide hole formed in the first guide jig. The second mattress body fixing step may be performed after the second preparation step and before the second-first adhesion step. In the second mattress body fixing step, the mattress body placed on the upper surface of the second support jig may be fixed by moving a second guide jig of the second pressing unit such that the upper end portion of the second support jig is inserted into a second guide hole formed in the second guide jig.

The first guide jig and the second guide jig may be arranged to be movable forward, backward, upward and downward.

The air mattress manufacturing method according to the present invention may further include a first alignment step, a second alignment step, a third alignment step, and a fourth alignment step. The first alignment step may be performed after the first mattress body fixing step and before the first-first adhesion step. In the first alignment step, a first alignment slider of the first pressing unit, on which the first heating presser and the first cooling presser are installed, may be slid leftward and rightward along a first linear rail of the first pressing unit to align the first heating presser to an upper side of the first guide hole. The second alignment step may be performed after the first-first adhesion step and before the first-second adhesion step. In the second alignment step, the first alignment slider may be slid leftward and rightward along the first linear rail to align the first cooling presser to the upper side of the first guide hole. The third alignment step may be performed after the second mattress body fixing step and before the second-first adhesion step. In the third alignment step, a second alignment slider of the second pressing unit, on which the second heating presser and the second cooling presser are installed, may be slid leftward and rightward along a second linear rail of the second pressing unit to align the second heating presser to an upper side of the second guide hole. The fourth alignment step may be performed after the second-first adhesion step and before the second-second adhesion step. In the fourth alignment step, the second alignment slider may be slid leftward and rightward along the second linear rail to align the second cooling presser to the upper side of the second guide hole.

An air mattress according to the present invention is manufactured using an air mattress manufacturing method according to the present invention.

Specific details of other embodiments are included in the detailed description and drawings.

### Advantageous Effects

An air mattress manufacturing apparatus, an air mattress manufacturing method using the same, and an air mattress manufactured using the manufacturing method according to the present invention first adhere a center portion of a shape-maintaining member to four corner portions of a mattress body, and then adhere an upper end portion of the shape-maintaining member or a lower end portion of the shape-maintaining member to the four corner portions of the mattress body, and thus the shape-maintaining member can be firmly adhered to the four corner portions of the mattress body, and there is an effect of preventing burns to the worker because the worker does not directly apply hot air to the shape-maintaining member.

The effects of the present invention are not limited to the effects mentioned above, and other effects not mentioned will be clearly understood by those skilled in the art from the description of the claims.

### DESCRIPTION OF DRAWINGS

FIG. 1 is a drawing illustrating an air mattress manufactured by an air mattress manufacturing apparatus according to an embodiment of the present invention,

FIG. 2 is a cross-sectional view of an edge portion of the air mattress illustrated in FIG. 1,

FIG. 3 is a perspective view illustrating an air mattress manufacturing apparatus according to an embodiment of the present invention,

FIG. 4 is a front view of the first pressing unit and the second pressing unit illustrated in FIG. 3,

FIG. 5 is a right side view of the first pressing unit and the second pressing unit illustrated in FIG. 3,

FIG. 6 is a drawing illustrating a state in which the upper end portion of the shape-maintaining member is adhered to the corner upper surface of the mattress body by the second pressing unit illustrated in FIG. 3,

FIG. 7 is a flow chart illustrating a process of adhering the center portion of the shape-maintaining member to the corner side surface of the mattress body with the first pressing unit illustrated in FIG. 3, and

FIG. 8 is a flowchart illustrating a process of adhering the upper end portion of the shape-maintaining member to the corner upper surface of the mattress body or adhering the lower end portion of the shape-maintaining member to the corner lower surface of the mattress body with the second pressing unit illustrated in FIG. 3.

### MODE FOR DISCLOSURE

Hereinafter, an air mattress manufacturing apparatus, an air mattress manufacturing method using the same, and an air mattress manufactured using the manufacturing method according to an embodiment of the present invention will be described with reference to the drawings.

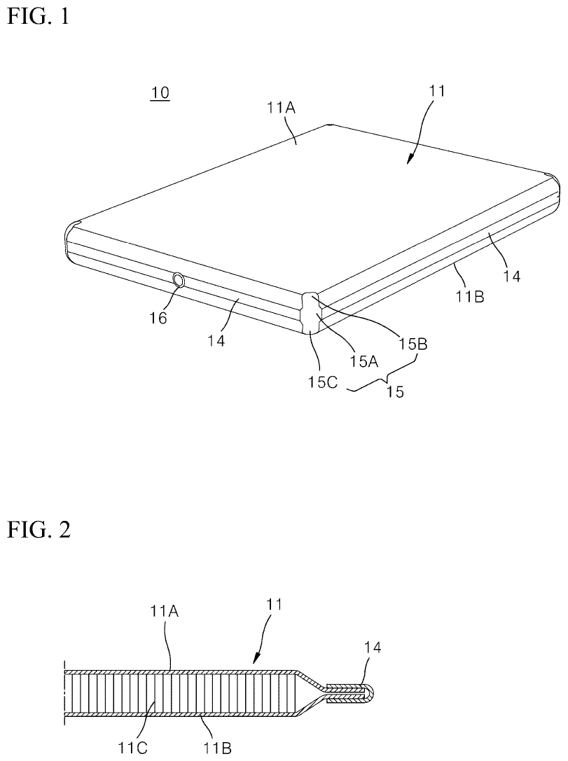

FIG. 1 is a drawing illustrating an air mattress manufactured by an air mattress manufacturing apparatus according to an embodiment of the present invention, and FIG. 2 is a cross-sectional view of an edge portion of the air mattress illustrated in FIG. 1.

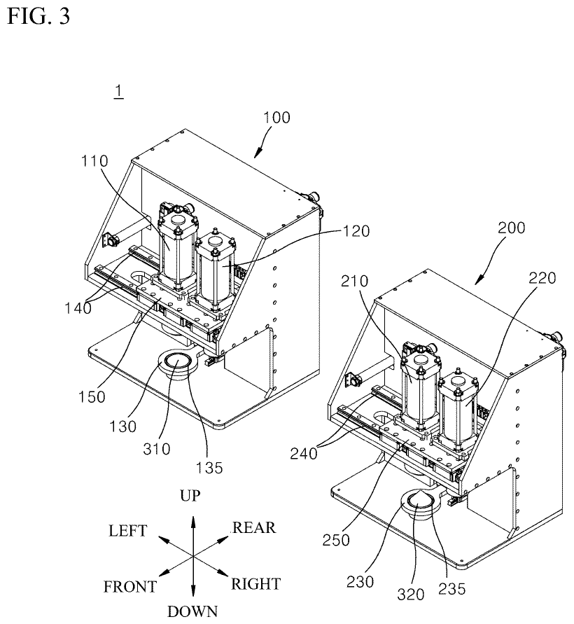

Referring to FIGS. 1 and 2, an air mattress 10 manufactured by an air mattress manufacturing apparatus 1 (see FIG. 3) according to an embodiment of the present invention may include a mattress body 11 tailored to fit the size of the air mattress 10 (e.g., king size, queen size, super single size, etc.), a sealing tape 14 adhered to the edge portion of the mattress body 11, and a shape-maintaining member 15 adhered to the four corner portions of the mattress body 11.

The mattress body 11 may be formed as a hexahedron by a shape-maintaining member 15 adhered to the four corner portions of the mattress body 11, and in this state, the sealing tape 14 may seal the four side surfaces of the mattress body 11.

The mattress body 11 may include an upper plate portion 11A, a lower plate portion 11B, and a plurality of strings 11C. However, the technical feature of the present invention is to adhere the shape-maintaining member 15 to the four corner portions of the mattress body 11 constituting the air mattress 10 at an accurate position, and in order to achieve this technical feature, the mattress body 11 may be constituted by only the upper plate portion 11A and the lower plate portion 11B without including the plurality of strings 11C.

That is, when a plurality of strings 11C are not provide, the air mattress 10 may be manufactured by sealing the edges of the upper plate portion 11A and the lower plate portion 11B with a sealing tape 14 in a state in which the upper plate portion 11A and the lower plate portion 11B are overlapped, and then adhering shape-maintaining members 15 to the four corner portions of the mattress body 11, and the air mattress 10 manufactured in this way can have cushioning force only by the pressure of the air filled inside.

In addition, even when a plurality of strings 11C are provide, the air mattress 10 may be manufactured by sealing the edges of the upper plate portion 11A and the lower plate portion 11B with a sealing tape 14 in a state in which the upper plate portion 11A and lower plate portion 11B are overlapped, and then adhering shape-maintaining members 15 to the four corner portions of the mattress body 11, and the air mattress 10 manufactured in this way can have more cushioning force due to the elastic force of the plurality of strings 11C in addition to the pressure of the air filled inside.

The upper plate portion 11A may be formed in a rectangular shape, and the lower plate portion 11B may be formed in a rectangular shape having the same size as the upper plate portion 11A.

The upper plate portion 11A and the lower plate portion 11B are tailored to fit the size of the air mattress 10 (e.g., king size, queen size, super single size, etc.), and then overlapped with each other in a vertical direction, and the edges of the mattress body 11 are sealed with a sealing tape 14 to form the basic shape of the air mattress 10.

As such, after forming the basic shape of the air mattress 10, the shape-maintaining members 15 may be adhered to the four corner portions of the mattress body 11 from the upper surface of the upper plate portion 11A to the lower surface of the lower plate portion 11B so that the mattress body 11 has a 3D hexahedral shape, and an air injection valve 16 may be installed on one side surface to complete the air mattress 10.

The shape-maintaining member 15 may include a center portion 15A, an upper end portion 15B, and a lower end portion 15C. The upper end portion 15B and the lower end portion 15C may have the same width, and the center portion 15A may have a width wider than those of the upper end portion 15B and the lower end portion 15C. The center portion 15A may be adhered to a corner side surface of the mattress body 11, the upper end portion 15B may be adhered to a corner upper surface of the mattress body 11, and the lower end portion 15C may be adhered to a corner lower surface of the mattress body 11.

Particularly, in the present embodiment, the shape-maintaining members 15 may be adhered to the exact adhesion positions in the four corner portions of the mattress body 11 because the center portion 15A is adhered to the corner side surface of the mattress body 11 before the upper end portion 15B and the lower end portion 15C, and then the upper end portion 15B is adhered to the corner upper surface of the mattress body 11 or the lower end portion 15C is adhered to the corner lower surface of the mattress body 11.

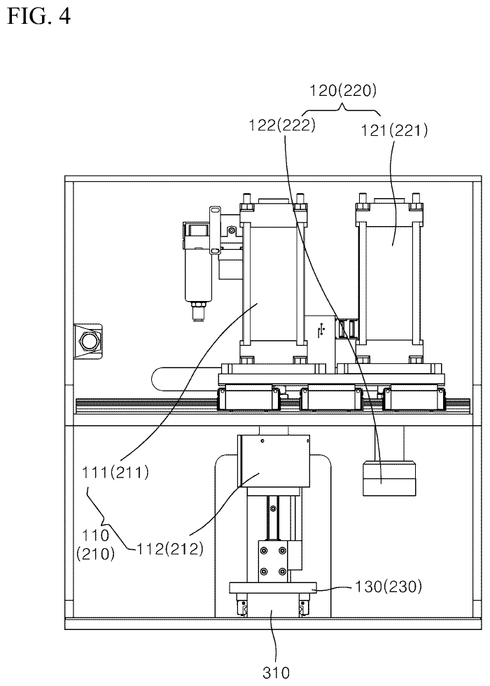

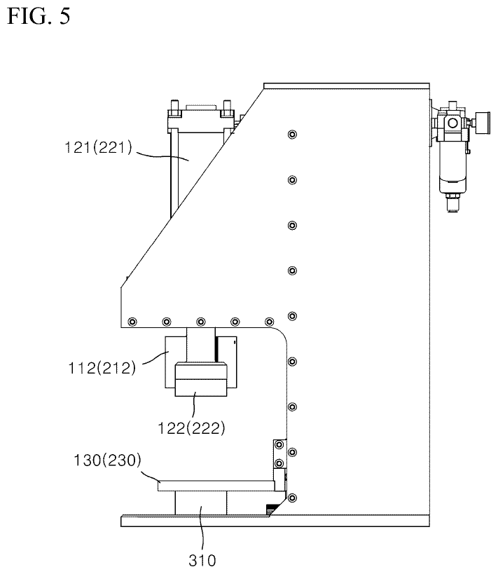

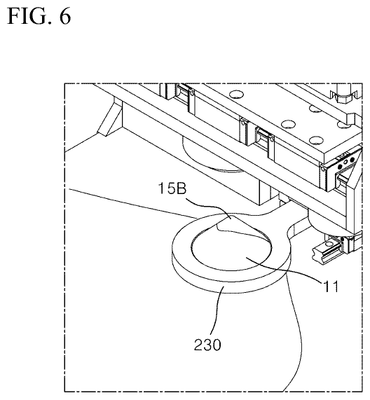

FIG. 3 is a perspective view illustrating an air mattress manufacturing apparatus according to an embodiment of the present invention, FIG. 4 is a front view of the first pressing unit and the second pressing unit illustrated in FIG. 3, FIG. 5 is a right side view of the first pressing unit and the second pressing unit illustrated in FIG. 3, and FIG. 6 is a drawing illustrating a state in which the upper end portion of the shape-maintaining member is adhered to the corner upper surface of the mattress body by the second pressing unit illustrated in FIG. 3.

Hereinafter, in the description, the directions such as forward, backward, upward, downward, leftward, rightward, and in related terms, are the same directions as those shown in FIG. 3.

Referring to FIGS. 3 to 6, an air mattress manufacturing apparatus 1 according to an embodiment of the present invention may be an apparatus for adhering shape-maintaining members 15 to four corner portions of a mattress body 11. An adhesive may be applied in advance to one surface of the shape-maintaining member 15 to be adhered to the corner portions of the mattress body 11.

With the sealing tape 14 adhered to the edge portions of the upper plate portion 11A and the lower plate portion 11B of the mattress body 11 overlapped vertically, the air mattress manufacturing apparatus 1 according to an embodiment of the present invention can maintain the mattress body 11 in a hexahedron by adhering shape-maintaining members 15 to four corner portions of the mattress body 11. That is, the shape-maintaining member 15 may be adhered to the four corner portions of the mattress body 11 to maintain the mattress body 11 in a hexahedron.

The air mattress manufacturing apparatus 1 according to an embodiment of the present invention may include a first pressing unit 100, a second pressing unit 200, a first support jig 310, and a second support jig 320.

The first pressing unit 100 may be an apparatus for adhering the center portion 15A of the shape-maintaining member 15 to the corner side surface of the mattress body 11, and the second pressing unit 200 may be an apparatus for adhering the upper end portion 15B of the shape-maintaining member 15 to the corner upper surface of the mattress body 11, or adhering the lower end portion 15C of the shape-maintaining member 15 to the corner lower surface of the mattress body 11. The first pressing unit 100 and the second pressing unit 200 may be formed with the same configuration.

The first support jig 310 and the second support jig 320 may be formed with different shapes in upper surfaces. That is, the upper surface of the first support jig 310 may be formed as a horizontal plane, and the upper surface of the second support jig 320 may be formed as an upwardly pointed cone shape. Specifically, the first support jig 310 may be formed as a cylinder shape with the upper surface formed as a horizontal plane, and the second support jig 320 may be formed as a cylinder shape with the upper surface formed as an upwardly pointed cone shape.

Of the corner portion of the mattress body 11, the portion to which the upper end portion or lower end portion of the shape-maintaining member 15 is adhered is formed in a pointed shape at the apex portion where three surfaces meet, and thus, in order to completely support the apex portion, the upper surface of the second support jig 320 may be formed in an upwardly pointed cone shape.

The center portion 15A of the shape-maintaining member 15 that is temporarily attached to the corner side surface of the mattress body 11 may be placed on the upper surface of the first support jig 310 by the worker.

That is, the worker may place the shape-maintaining member 15 temporarily attached to the corner side surface of the mattress body 11 on the upper surface of the first support jig 310 after the center portion 15A of the shape-maintaining member 15 is temporarily attached to the corner side surface of the mattress body 11.

The first pressing unit 100 may press the center portion 15A of the shape-maintaining member 15 placed on the upper surface of the first support jig 310 to adhere it to the corner side surface of the mattress body 11.

That is, the worker may press the center portion 15A of the shape-maintaining member 15 placed on the upper surface of the first support jig 310 with the first pressing unit 100 to adhere it to the corner side surface of the mattress body 11.

After the center portion 15A of the shape-maintaining member 15 adhered to the corner side surface of the mattress body 11 by the first pressing unit 100 is vertically folded in half together with the corner side surface of the mattress body 11 by the worker, the upper end portion 15B of the shape-maintaining member 15 temporarily attached to the corner upper surface of the mattress body 11 and the lower end portion 15C of the shape-maintaining member 15 temporarily attached to the corner lower surface of the mattress body 11 may be placed by the worker on the upper surface of the second support jig 320.

That is, after adhering the center portion 15A of the shape-maintaining member 15 to the corner side surface of the mattress body 11 with the first pressing unit 100, the worker may vertically fold the center portion 15A of the shape-maintaining member 15 in half together with the corner side surface of the mattress body 11. Thereafter, the worker may temporarily attach the upper end portion 15B of the shape-maintaining member 15 to the corner upper surface of the mattress body 11 and temporarily attach the lower end portion 15C of the shape-maintaining member 15 to the corner lower surface of the mattress body 11. Thereafter, the worker may place the upper end portion 15B of the shape-maintaining member 15 temporarily attached to the corner upper surface of the mattress body 11 and the lower end portion 15C of the shape-maintaining member 15 temporarily attached to the corner lower surface of the mattress body 11 on the upper surface of the second support jig 320.

The second pressing unit 200 may press the upper end portion 15B of the shape-maintaining member 15 placed on the upper surface of the second support jig 320 to adhere it to the corner upper surface of the mattress body 11, or press the lower end portion 15C of the shape-maintaining member 15 placed on the upper surface of the second support jig 320 to adhere it to the corner lower surface of the mattress body 11.

That is, the worker may press the upper end portion 15B of the shape-maintaining member 15 placed on the upper surface of the second support jig 320 with the second pressing unit 200 to adhere it to the corner upper surface of the mattress body 11. Alternatively, the worker may press the lower end portion 15C of the shape-maintaining member 15 placed on the upper surface of the second support jig 320 with the second pressing unit 200 to adhere it to the corner lower surface of the mattress body 11.

Specifically, the worker presses the upper end portion 15B of the shape-maintaining member 15 placed on the upper surface of the second support jig 320 with the second pressing unit 200 to adhere it to the corner upper surface of the mattress body 11, then flips the corner portion of the mattress body 11 upside down so that the lower end portion 15C of the shape-maintaining member 15 faces upward, and then presses the lower end portion 15C of the shape-maintaining member 15 placed on the upper surface of the second support jig 320 with the second pressing unit 200 to adhere it to the corner lower surface of the mattress body 11.

The first pressing unit 100 may include a first heating presser 110 and a first cooling presser 120.

The first heating presser 110 may heat and press the center portion 15A of the shape-maintaining member 15 placed on the upper surface of the first support jig 310.

The first heating presser 110 may include a cylinder 111 and a rod 112. The rod 112 may be withdrawn from the inside of the cylinder 111 or introduced into the inside of the cylinder 111 through the lower end of the cylinder 111. The rod 112 may be moved vertically by hydraulic pressure within the cylinder 111.

The cylinder 111 may constitute the upper part of the first heating presser 110, and the rod 112 may constitute the lower part of the first heating presser 110. The lower surface of the rod 112 may be a substantial part that applies heat and presses the center portion 15A of the shape-maintaining member 15 placed on the upper surface of the first support jig 310. A plurality of bar-shaped heaters that are heated by electricity may be inserted and installed at the lower end portion of the rod 112.

Hereinafter, in the description, the lower surface of the first heating presser 110 may mean the lower surface of the rod 112.

The first cooling presser 120 may press the center portion 15A of the shape-maintaining member 15 pressed by the first heating presser 110 without applying heat. That is, the center portion 15A of the shape-maintaining member 15 may be cooled by the first cooling presser 120 so that adhesion to the corner side surface of the mattress body 11 can be completed.

The first cooling presser 120 may include a cylinder 121 and a rod 122. The rod 122 may be withdrawn from the inside of the cylinder 121 or introduced into the inside of the cylinder 121 through the lower end of the cylinder 121. The rod 122 may be moved vertically by hydraulic pressure within the cylinder 121.

The cylinder 121 may constitute the upper part of the first cooling presser 120, and the rod 122 may constitute the lower part of the first cooling presser 120. The lower surface of the rod 122 may be a substantial part that presses the center portion 15A of the shape-maintaining member 15 pressed by the first heating presser 110 without applying heat.

Hereinafter, in the description, the lower surface of the first cooling presser 120 may mean the lower surface of the rod 122.

Since the upper surface of the first support jig 310 is formed as a horizontal plane, the lower surface of the rod 112, which is the lower surface of the first heating presser 110, may be formed as a horizontal plane corresponding to the upper surface of the first support jig 310, and the lower surface of the rod 122, which is the lower surface of the first cooling presser 120, may also be formed as a horizontal plane corresponding to the upper surface of the first support jig 310.

The second pressing unit 200 may include a second heating presser 210 and a second cooling presser 220.

The second heating presser 210 may heat and press the upper end portion 15B of the shape-maintaining member 15 placed on the upper surface of the second support jig 320, or heat and press the lower end portion 15C of the shape-maintaining member 15 placed on the upper surface of the second support jig 320.

The second heating presser 210 may include a cylinder 211 and a rod 212. The rod 212 may be withdrawn from the inside of the cylinder 211 or introduced into the inside of the cylinder 211 through the lower end of the cylinder 211. The rod 212 may be moved vertically by hydraulic pressure within the cylinder 211.

The cylinder 211 may constitute the upper part of the second heating presser 210, and the rod 212 may constitute the lower part of the second heating presser 210. The lower surface of the rod 212 may be a substantial part that heats and presses the upper end portion 15B of the shape-maintaining member 15 placed on the upper surface of the second support jig 320, or heats and presses the lower end portion 15C of the shape-maintaining member 15 placed on the upper surface of the second support jig 320. A plurality of bar-shaped heaters that are heated by electricity may be inserted and installed at the lower end portion of the rod 212.

Hereinafter, in the description, the lower surface of the second heating presser 210 may mean the lower surface of the rod 212.

The second cooling presser 220 may press the upper end portion 15B of the shape-maintaining member 15 pressed by the second heating presser 210 without applying heat, or may press the lower end portion 15C of the shape-maintaining member 15 pressed by the second heating presser 210 without applying heat. That is, the upper end portion 15B of the shape-maintaining member 15 may be cooled by the second cooling presser 220 so that adhesion to the corner upper surface of the mattress body 11 can be completed, and the lower end portion 15C of the shape-maintaining member 15 may be cooled by the second cooling presser 220 so that adhesion to the corner lower surface of the mattress body 11 can be completed.

The second cooling presser 220 may include a cylinder 221 and a rod 222. The rod 222 may be withdrawn from the inside of the cylinder 221 or introduced into the inside of the cylinder 221 through the lower end of the cylinder 221. The rod 222 may be moved vertically by hydraulic pressure within the cylinder 221.

The cylinder 221 may constitute the upper part of the second cooling presser 220, and the rod 222 may constitute the lower part of the second cooling presser 220. The lower surface of the rod 222 may be a substantial part that presses the upper end portion 15B of the shape-maintaining member 15 pressed by the second heating presser 210 without applying heat, or presses the lower end portion 15C of the shape-maintaining member 15 pressed by the second heating presser 210 without applying heat.

Hereinafter, in the description, the lower surface of the second cooling presser 220 may mean the lower surface of the rod 222.

Since the upper surface of the second support jig 320 is formed in an upwardly pointed cone shape, the lower surface of the rod 212, which is the lower surface of the second heating presser 210, may be formed in a conical groove corresponding to the upper surface of the second support jig 320, and the lower surface of the rod 222, which is the lower surface of the second cooling presser 220, may also be formed in a conical groove corresponding to the upper surface of the second support jig 320.

The first pressing unit 100 may further include a first guide jig 130. The first guide jig 130 may be arranged to be movable forward, backward, upward, and downward. The first guide jig 130 may be moved forward, backward, upward, and downward by the driving force of the electric motors. In a state in which the center portion 15A of the shape-maintaining member 15 is placed on the upper surface of the first support jig 310, the first guide jig 130 may be moved forward and then downward by the driving force of the electric motors, thereby fixing the corner portion of the mattress body 11 placed on the upper surface of the first support jig 310.

A first guide hole 135 may be formed in the first guide jig 130. The first guide hole 135 may be formed in a circular shape corresponding to the shape of the outer circumferential surface of the first support jig 310. The first guide jig 130 may be moved to the first support jig 310 such that the upper end portion of the first support jig 310 may be inserted into the first guide hole 135, thereby fixing the mattress body 11 placed on the upper surface of the first support jig 310.

The second pressing unit 200 may further include a second guide jig 230. The second guide jig 230 may be arranged to be movable forward, backward, upward, and downward. The second guide jig 230 may be moved forward, backward, upward, and downward by the driving force of the electric motors. In a state in which the upper end portion 15B and the lower end portion 15C of the shape-maintaining member 15 are placed on the upper surface of the second support jig 320, the second guide jig 230 may be moved forward and then downward by the driving force of the electric motors, thereby fixing the corner portion of the mattress body 11 placed on the upper surface of the second support jig 320.

A second guide hole 235 may be formed in the second guide jig 230. The second guide hole 235 may be formed in a circular shape corresponding to the shape of the outer circumferential surface of the second support jig 320. The second guide jig 230 may be moved to the second support jig 320 such that the upper end portion of the second support jig 320 is inserted into the second guide hole 235, thereby fixing the mattress body 11 placed on the upper surface of the second support jig 320.

The first pressing unit 100 may further include a first linear rail 140 and a first alignment slider 150.

The first linear rail 140 may include a pair of first linear rails 140 that are spaced apart from each other in a front-to-back direction and arranged parallel to each other. The pair of first linear rails 140 may be formed to be long leftward and rightward.

A first heating presser 110 and a first cooling presser 120 may be installed in the first alignment slider 150. The cylinder 111 of the first heating presser 110 and the cylinder 121 of the first cooling presser 120 may be arranged to protrude upward from the first alignment slider 150, and the rod 112 of the first heating presser 110 and the rod 122 of the first cooling presser 120 may be arranged to protrude downward from the first alignment slider 150 by penetrating holes formed in the first alignment slider 150.

The first alignment slider 150 may be slid leftward and rightward along the first linear rail 140 by the driving force of the electric motor. The first alignment slider 150 may be slid leftward and rightward along the first linear rail 140 to align one of the first heating presser 110 and the first cooling presser 120 to the upper side of the first guide hole 135. A state such as FIG. 3 is a state in which the first alignment slider 150 is slid rightward along the first linear rail 140, and may be a state in which the first heating presser 110 is aligned to the upper side of the first guide hole 135. In a state such as FIG. 3, the first alignment slider 150 may be slid leftward along the first linear rail 140 to align the first cooling presser 120 to the upper side of the first guide hole 135.

The second pressing unit 200 may further include a second linear rail 240 and a second alignment slider 250.

The second linear rail 240 may include a pair of second linear rails 240 that are spaced apart from each other in a front-to-back direction and arranged parallel to each other. The pair of second linear rails 240 may be formed to be long leftward and rightward.

A second heating presser 210 and a second cooling presser 220 may be installed in the second alignment slider 250. The cylinder 211 of the second heating presser 210 and the cylinder 221 of the second cooling presser 220 may be arranged to protrude upward from the second alignment slider 250, and the rod 212 of the second heating presser 210 and the rod 222 of the second cooling presser 220 may be arranged to protrude downward from the second alignment slider 250 by penetrating through holes formed in the second alignment slider 250.

The second alignment slider 250 may be slid leftward and rightward along the second linear rail 240 by the driving force of the electric motor. The second alignment slider 250 may be slid leftward and rightward along the second linear rail 240 to align one of the second heating presser 210 and the second cooling presser 220 to the upper side of the second guide hole 235. A state such as FIG. 3 is a state in which the second alignment slider 250 is slid rightward along the second linear rail 240, and may be a state in which the second heating presser 210 is aligned to the upper side of the second guide hole 235. In a state such as FIG. 3, the second alignment slider 250 may be slid leftward along the second linear rail 240 to align the second cooling presser 220 to the upper side of the second guide hole 235.

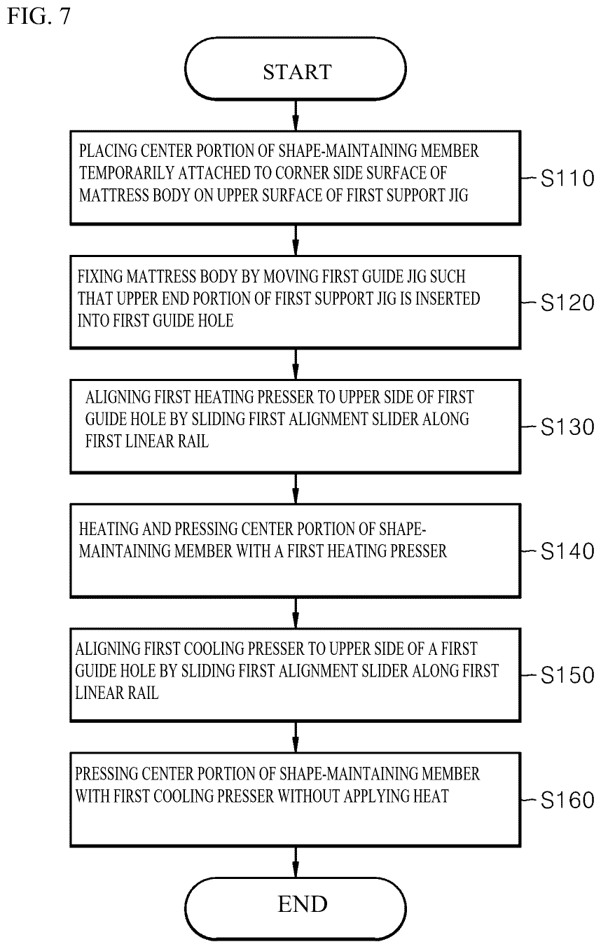

FIG. 7 is a flow chart illustrating a process of adhering the center portion of the shape-maintaining member to the corner side surface of the mattress body with the first pressing unit illustrated in FIG. 3.

Referring to FIG. 7, a method of adhering a center portion 15A of a shape-maintaining member 15 to a corner side surface of a mattress body 11 may include a first preparation step S110 and a first adhesion step S140, S160.

In the first preparation step S110, a worker may place the center portion 15A of the shape-maintaining member 15 temporarily attached to the corner side surface of the mattress body 11 on the upper surface of the first support jig 310.

Specifically, in the first preparation step S110, the worker may temporarily attach the center portion 15A of the shape-maintaining member 15 to the corner side surface of the mattress body 11, and then place the center portion 15A of the shape-maintaining member 15 temporarily attached to the corner side surface of the mattress body 11 on the upper surface of the first support jig 310.

In the first adhesion step S140, S160, the center portion 15A of the shape-maintaining member 15 placed on the upper surface of the first support jig 310 may be adhered to the corner side surface of the mattress body 11 by pressing it with the first pressing unit 100.

The first adhesion step S140, S160 may include a first-first adhesion step S140 and a first-second adhesion step S160.

In the first-first adhesion step S140, the center portion 15A of the shape-maintaining member 15 placed on the upper surface of the first support jig 310 may be heated and pressed by a first heating presser 110 of the first pressing unit 100. In this way, the adhesive that was previously applied to the adhesion surface of the center portion 15A of the shape-maintaining member 15 melts due to the heat of the first heating presser 110, so that the center portion 15A of the shape-maintaining member 15 may be adhered to the corner side surface of the mattress body 11.

In the first-second adhesion step S160, the center portion 15A of the shape-maintaining member 15 pressed by the first heating presser 110 may be pressed by the first cooling presser 120 of the first pressing unit 100 without applying heat. In this way, as the adhesive melted by the heat of the first heating presser 110 is cooled, the center portion 15A of the shape-maintaining member 15 may be completely adhered to the corner side surface of the mattress body 11.

After the first preparation step S110, a first mattress body fixing step S120 may be performed before the first-first adhesion step S140.

In the first mattress body fixing step S120, the mattress body 11 placed on the upper surface of the first support jig 310 may be fixed by moving the first guide jig 130 of the first pressing unit 100 such that the upper end portion of the first support jig 310 is inserted into the first guide hole 135 formed in the first guide jig 130.

After the first mattress body fixing step S120, a first alignment step S130 may be performed before the first-first adhesion step S140.

In the first alignment step S130, the first heating presser 110 may be aligned to the upper side of the first guide hole 135 of the first guide jig 130 by sliding the first alignment slider 150 of the first pressing unit 100, on which the first heating presser 110 and the first cooling presser 120 are installed, leftward and rightward along the first linear rail 140 of the first pressing unit 100. Accordingly, in the first-first adhesion step S140, the rod 112 of the first heating presser 110 may be moved downward so that the center portion 15A of the shape-maintaining member 15 can be accurately pressed.

After the first-first adhesion step S140, a second alignment step S150 may be performed before the first-second adhesion step S160.

In the second alignment step S150, the first cooling presser 120 can be aligned to the upper side of the first guide hole 135 of the first guide jig 130 by sliding the first alignment slider 150 leftward and rightward along the first linear rail 140. Accordingly, in the first-second adhesion step S160, the rod 122 of the first cooling presser 120 may be moved downward so that the center portion 15A of the shape-maintaining member 15 can be accurately pressed.

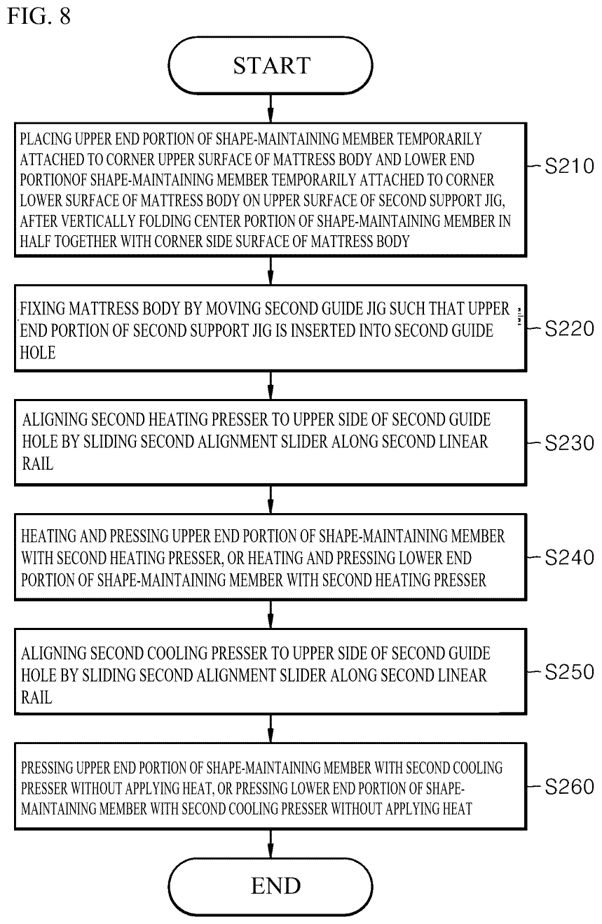

FIG. 8 is a flowchart illustrating a process of adhering the upper end portion of the shape-maintaining member to the corner upper surface of the mattress body or adhering the lower end portion of the shape-maintaining member to the corner lower surface of the mattress body with the second pressing unit illustrated in FIG. 3.

Referring to FIG. 8, the method of adhering the upper end portion 15B of the shape-maintaining member 15 to the corner upper surface of the mattress body 11 or adhering the lower end portion 15C of the shape-maintaining member 15 to the corner lower surface of the mattress body 11 may include a second preparation step S210 and a second adhesion step S240, S260.

In the second preparation step S210, the worker vertically folds the center portion 15A of the shape-maintaining member 15 adhered to the corner side surface of the mattress body 11 by the first pressing unit 100 in half together with the corner side surface of the mattress body 11, and then places the upper end portion 15B of the shape-maintaining member 15 temporarily attached to the corner upper surface of the mattress body 11 and the lower end portion 15C of the shape-maintaining member 15 temporarily attached to the corner lower surface of the mattress body 11 on the upper surface of the second support jig 320.

Specifically, in the second preparation step S210, the worker vertically folds the center portion of the shape-maintaining member adhered to the corner side surface of the mattress body by the first pressing unit in half together with the corner side surface of the mattress body 11, and then temporarily attaches the upper end portion 15B of the shape-maintaining member 15 to the corner upper surface of the mattress body 11 and the lower end portion 15C of the shape-maintaining member 15 to the corner lower surface of the mattress body 11, and then places the upper end portion 15B of the shape-maintaining member 15 temporarily attached to the corner upper surface of the mattress body 11 and the lower end portion 15C of the shape-maintaining member 15 temporarily attached to the corner lower surface of the mattress body 11 on the upper surface of the second support jig 320.

In the second adhesion step S240, S260, the upper end portion 15B of the shape-maintaining member 15 placed on the upper surface of the second support jig 320 may be pressed by the second pressing unit 200 to be adhered to the corner upper surface of the mattress body 11, or the lower end portion 15C of the shape-maintaining member 15 placed on the upper surface of the second support jig 320 may be pressed by the second pressing unit 200 to be adhered to the corner lower surface of the mattress body 11.

In the second adhesion step S240, S260, the worker may press the upper end portion 15B of the shape-maintaining member 15 placed on the upper surface of the second support jig 320 with the second pressing unit 200 so as to adhere it to the corner upper surface of the mattress body 11, then turn the corner portion of the mattress body 11 upside down, and press the lower end portion 15C of the shape-maintaining member 15 placed on the upper surface of the second support jig 320 with the second pressing unit 200 so as to adhere it to the corner lower surface of the mattress body 11. Of course, in the second adhesion step S240, S260, the worker may press the lower end portion 15C of the shape-maintaining member 15 placed on the upper surface of the second support jig 320 with the second pressing unit 200 so as to adhere it to the corner lower surface of the mattress body 11, then turn the corner portion of the mattress body 11 upside down, and then press the upper end portion 15B of the shape-maintaining member 15 placed on the upper surface of the second support jig 320 with the second pressing unit 200 so as to adhere it to the corner upper surface of the mattress body 11.

The second adhesion step S240, S260 may include a second-first adhesion step S240 and a second-second adhesion step S260.

In the second-first adhesion step S240, the upper end portion 15B of the shape-maintaining member 15 placed on the upper surface of the second support jig 320 may be heated and pressed by the second heating presser 210 of the second pressing unit 200, or the lower end portion 15C of the shape-maintaining member 15 placed on the upper surface of the second support jig 320 may be heated and pressed by the second heating presser 210. When the upper end portion 15B of the shape-maintaining member 15 placed on the upper surface of the second support jig 320 is heated and pressed by the second heating presser 210, the adhesive previously applied to the adhesion surface of the upper end portion 15B of the shape-maintaining member 15 melts due to the heat of the second heating presser 210, so that the upper end portion 15B of the shape-maintaining member 15 can be adhered to the corner upper surface of the mattress body 11. Alternatively, when the lower end portion 15C of the shape-maintaining member 15 placed on the upper surface of the second support jig 320 is heated and pressed by the second heating presser 210, the adhesive that was previously applied to the adhesion surface of the lower end portion 15C of the shape-maintaining member 15 melts due to the heat of the second heating presser 210, so that the lower end portion 15C of the shape-maintaining member 15 can be adhered to the corner lower surface of the mattress body 11.

In the second-second adhesion step S260, the upper end portion 15B of the shape-maintaining member 15 pressed by the second heating presser 210 may be pressed by the second cooling presser 220 of the second pressing unit 200 without applying heat, or the lower end portion 15C of the shape-maintaining member 15 pressed by the second heating presser 210 may be pressed by the second cooling presser 220 without applying heat. When the upper end portion 15B of the shape-maintaining member 15 pressed by the second heating presser 210 is pressed by the second cooling presser 220 without applying heat, the upper end portion 15B of the shape-maintaining member 15 may be completely adhered to the corner upper surface of the mattress body 11 as the adhesive melted by the heat of the second heating presser 210 is cooled. Alternatively, when the lower end portion 15C of the shape-maintaining member 15 pressed by the second heating presser 210 is pressed by the second cooling presser 220 without applying heat, the lower end portion 15C of the shape-maintaining member 15 may be completely adhered to the corner lower surface of the mattress body 11 as the adhesive melted by the heat of the second heating presser 210 is cooled.

After the second preparation step S210, a second mattress body fixing step S220 may be performed before the second-first adhesion step S240.

In the second mattress body fixing step S220, the mattress body 11 placed on the upper surface of the second support jig 320 may be fixed by moving a second guide jig 230 of the second pressing unit 200 such that the upper end portion of the second support jig 320 is inserted into the second guide hole 235 formed in the second guide jig 230.

After the second mattress body fixing step S220, a third alignment step S230 may be performed before the second-first adhesion step S240.

In the third alignment step S230, the second heating presser 210 may be aligned to the upper side of the second guide hole 235 of the second guide jig 230 by sliding the second alignment slider 250 of the second pressing unit 200, on which the second heating presser 210 and the second cooling presser 220 are installed, leftward and rightward along the second linear rail 240 of the second pressing unit 200. Accordingly, in the second-first adhesion step S240, the rod 212 of the second heating presser 210 may be moved downward to accurately press the upper end portion 15B of the shape-maintaining member 15 or accurately press the lower end portion 15C of the shape-maintaining member 15.

After the second-first adhesion step S240, a fourth alignment step S250 may be performed before the second-second adhesion step S260.

In the fourth alignment step S250, the second cooling presser 220 may be aligned to the upper side of the second guide hole 235 of the second guide jig 230 by sliding the second alignment slider 250 leftward and rightward along the second linear rail 240. Accordingly, in the second-second adhesion step S260, the rod 222 of the second cooling presser 220 may be moved downward to accurately press the upper end portion 15B of the shape-maintaining member 15 or accurately press the lower end portion 15C of the shape-maintaining member 15.

As described above, the air mattress manufacturing apparatus 1, the air mattress manufacturing method using the same and the air mattress 10 manufactured using the manufacturing method according to an embodiment of the present invention first adhere the center portion 15A of the shape-maintaining member 15 to the four corner portions of the mattress body 11, and then adhere the upper end portion 15B of the shape-maintaining member 15 or the lower end portion 15C of the shape-maintaining member 15 to the four corner portions of the mattress body 11, and thus the shape-maintaining member 15 can be firmly adhered to the four corner portions of the mattress body 11, and because the worker does not directly apply hot air to the shape-maintaining member 15, burns to the worker can be prevented.

1. An air mattress manufacturing apparatus, for adhering shape-maintaining members to four corner portions of a mattress body, the shape-maintaining members being adhered to the corner portions of the mattress body to maintain the mattress body in a hexahedron, the air mattress manufacturing apparatus comprising:
a first support jig having an upper surface on which a center portion of the shape-maintaining member, temporarily attached to a corner side surface of the mattress body, is placed by a worker;
a first pressing unit configured to press the center portion of the shape-maintaining member, which is placed on the upper surface of the first support jig, to adhere same to the corner side surface of the mattress body;
a second support jig having an upper surface on which an upper end portion of the shape-maintaining member, temporarily attached to a corner upper surface of the mattress body, and a lower end portion of the shape-maintaining member, temporarily attached to a corner lower surface of the mattress body, are placed by the worker, after the center portion of the shape-maintaining member, which is adhered to the corner side surface of the mattress body by the first pressing unit, is vertically folded in half together with the corner side surface of the mattress body by the worker; and
a second pressing unit configured to press the upper end portion of the shape-maintaining member, which is placed on the upper surface of the second support jig, to adhere same to the corner upper surface of the mattress body, or press the lower end portion of the shape-maintaining member, which is placed on the upper surface of the second support jig, to adhere same to the corner lower surface of the mattress body.

2. The air mattress manufacturing apparatus of claim 1,
wherein the upper surface of the first support jig is formed as a horizontal plane, and
the upper surface of the second support jig is formed as an upwardly pointed cone shape.

3. The air mattress manufacturing apparatus of claim 1,
wherein the first pressing unit includes:
a first heating presser configured to heat and press the center portion of the shape-maintaining member placed on the upper surface of the first support jig; and
a first cooling presser configured to press the center portion of the shape-maintaining member pressed by the first heating presser without applying heat, and
the second pressing unit includes:
a second heating presser configured to heat and press the upper end portion of the shape-maintaining member placed on the upper surface of the second support jig, or heat and press the lower end portion of the shape-maintaining member placed on the upper surface of the second support jig; and
a second cooling presser configured to press the upper end portion of the shape-maintaining member pressed by the second heating presser without applying heat, or press the lower end portion of the shape-maintaining member pressed by the second heating presser without applying heat.

4. The air mattress manufacturing apparatus of claim 3,
wherein the first pressing unit further includes:
a first guide jig in which a first guide hole is formed, and which is moved to the first support jig such that an upper end portion of the first support jig is inserted into the first guide hole, to fix the mattress body placed on the upper surface of the first support jig, and
the second pressing unit further includes:
a second guide jig in which a second guide hole is formed, and which is moved to the second support jig such that an upper end portion of the second support jig is inserted into the second guide hole, to fix the mattress body placed on the upper surface of the second support jig.

5. The air mattress manufacturing apparatus of claim 4,
wherein the first guide jig and the second guide jig are arranged to be movable forward, backward, upward and downward.

6. The air mattress manufacturing apparatus of claim 4,
wherein the first pressing unit further includes:
a first linear rail; and
a first alignment slider on which the first heating presser and the first cooling presser are installed, the first alignment slider sliding leftward and rightward along the first linear rail to align one of the first heating presser and the first cooling presser to an upper side of the first guide hole, and
the second pressing unit further includes:
a second linear rail; and
a second alignment slider on which the second heating presser and the second cooling presser are installed, the second alignment slider sliding leftward and rightward along the second linear rail to align one of the second heating presser and the second cooling presser to an upper side of the second guide hole.

7. An air mattress manufacturing method, for adhering shape-maintaining members to four corner portions of a mattress body, the shape-maintaining members being adhered to the corner portions of the mattress body to maintain the mattress body in a hexahedron, the air mattress manufacturing method comprising:
a first preparation step of placing, by a worker, a center portion of the shape-maintaining member, temporarily attached to a corner side surface of the mattress body, on an upper surface of a first support jig;
a first adhesion step of adhering the center portion of the shape-maintaining member, which is placed on the upper surface of the first support jig, to the corner side surface of the mattress body, by pressing same with a first pressing unit;
a second preparation step of placing, by the worker, an upper end portion of the shape-maintaining member, temporarily attached to a corner upper surface of the mattress body, and a lower end portion of the shape-maintaining member, temporarily attached to a corner lower surface the mattress body, on an upper surface of a second support jig, after vertically folding, by the worker, the center portion of the shape-maintaining member adhered to the corner side surface of the mattress body by the first pressing unit in half together with the corner side surface of the mattress body; and
a second adhesion step of adhering the upper end portion of the shape-maintaining member, which is placed on the upper surface of the second support jig, to the corner upper surface of the mattress body, by pressing same with a second pressing unit, or adhering the lower end portion of the shape-maintaining member, which is placed on the upper surface of the second support jig, to the corner lower surface of the mattress body, by pressing same with the second pressing unit.

8. The air mattress manufacturing method of claim 7,
wherein the upper surface of the first support jig is formed as a horizontal plane, and
the upper surface of the second support jig is formed as an upwardly pointed cone shape.

9. The air mattress manufacturing method of claim 7,
wherein the first adhesion step includes:
a first-first adhesion step of heating and pressing the center portion of the shape-maintaining member, which is placed on the upper surface of the first support jig, with a first heating presser of the first pressing unit; and
a first-second adhesion step of pressing the center portion of the shape-maintaining member pressed by the first heating presser, with a first cooling presser of the first pressing unit without applying heat, and
the second adhesion step includes:
a second-first adhesion step of heating and pressing the upper end portion of the shape-maintaining member, which is placed on the upper surface of the second support jig, with a second heating presser of the second pressing unit, or heating and pressing the lower end portion of the shape-maintaining member, which is placed on the upper surface of the second support jig, with the second heating presser; and
a second-second adhesion step of pressing the upper end portion of the shape-maintaining member pressed by the second heating presser, with a second cooling presser of the second pressing unit without applying heat, or pressing the lower end portion of the shape-maintaining member pressed by the second heating presser, with the second cooling presser without applying heat.

10. The air mattress manufacturing method of claim 9, further comprising:
a first mattress body fixing step of fixing the mattress body placed on the upper surface of the first support jig, by moving a first guide jig of the first pressing unit such that an upper end portion of the first support jig is inserted into a first guide hole formed in the first guide jig, after the first preparation step and before the first-first adhesion step; and
a second mattress body fixing step of fixing the mattress body placed on the upper surface of the second support jig, by moving a second guide jig of the second pressing unit such that an upper end portion of the second support jig is inserted into a second guide hole formed in the second guide jig, after the second preparation step and before the second-first adhesion step.

11. The air mattress manufacturing method of claim 10,
wherein the first guide jig and the second guide jig are arranged to be movable forward, backward, upward and downward.

12. The air mattress manufacturing method of claim 10, further comprising:
a first alignment step of aligning the first heating presser to an upper side of the first guide hole by sliding a first alignment slider of the first pressing unit, on which the first heating presser and the first cooling presser are installed, leftward and rightward along a first linear rail of the first pressing unit, after the first mattress body fixing step and before the first-first adhesion step;
a second alignment step of aligning the first cooling presser to the upper side of the first guide hole by sliding the first alignment slider leftward and rightward along the first linear rail, after the first-first adhesion step and before the first-second adhesion step;
a third alignment step of aligning the second heating presser to an upper side of the second guide hole by sliding a second alignment slider of the second pressing unit, on which the second heating presser and the second cooling presser are installed, leftward and rightward along a second linear rail of the second pressing unit, after the second mattress body fixing step and before the second-first adhesion step; and
a fourth alignment step of aligning the second cooling presser to the upper side of the second guide hole by sliding the second alignment slider leftward and rightward along the second linear rail, after the second-first adhesion step and before the second-second adhesion step.

13. An air mattress manufactured using the air mattress manufacturing method according to claim 7.
